(19) United States
(12) Patent Application Publication
(10) Pub. No.: US 2021/0294163 A1
(43) Pub. Date: Sep. 23, 2021

(54) DISPLAY DEVICE

(71) Applicant: FlexEnable Limited, Cambridgeshire (GB)

(72) Inventors: William Reeves, Cambridgeshire (GB); James Harding, Cambridgeshire (GB)

(21) Appl. No.: 16/821,401

(22) Filed: Mar. 17, 2020

(51) Int. Cl. G02F 1/1343; G02F 1/1335; G02F 1/1337

(52) U.S. Cl. CPC G02F 1/134363; G02F 1/133528; G02F 2001/133548; G02F 2001/133757; G02F 1/133753

(57) ABSTRACT

We disclose herewith a display device comprising a plurality of pixels. Each pixel comprises a first encapsulation layer; a second encapsulation layer; and a display medium disposed between the first and second encapsulation layers. The first encapsulation layer is disposed above an upper surface of the display medium and the second encapsulation layer is disposed below a lower surface of the display medium. A plurality of electrodes extends laterally through the display medium. The plurality of electrodes is oriented at an oblique angle relative to an axis extending between two opposing edges of the pixel.

### RELATED APPLICATIONS

The present invention is a Nonprovisional Application under 35 USC 111(a), claiming priority to Serial No. GB 1904482.5, filed on 29 Mar. 2019 the entirety of which is incorporated herein by reference.

### TECHNICAL FIELD

The present disclosure relates to a display device for off-axis viewing, in particular to a liquid crystal display (LCD) for off-axis viewing.

### BACKGROUND

A variety of display devices have been developed. Examples thereof include liquid crystal display (LCD) devices and organic light emitting display (OLED) devices. These displays are generally used in various electronic devices such as a mobile telephones, televisions, digital signage etc.

LCDs are usually optimised for wide horizontal viewing angles, and to some extent vertical viewing angles. This means that off-axis brightness and contrast quality is reduced, in particular when viewed in a viewing cone at approximately 45° to the normal. This is especially a problem for installations, such as A-pillar displays in cars, where display when mounted to the A-pillar is always viewed at 45° due to the shape and position of the A-pillar.

### SUMMARY

According to one aspect of the present invention there is provided a display device, the device comprising: a plurality of pixels, wherein each pixel comprises: a first encapsulation layer; a second encapsulation layer; a display medium disposed between the first and second encapsulation layers, wherein the first encapsulation layer is disposed above an upper surface of the display medium and the second encapsulation layer is disposed below a lower surface of the display medium; and a plurality of electrodes extending laterally through the display medium, wherein the plurality of electrodes are oriented at an oblique angle relative to an axis extending between two opposing edges of the pixel.

This has the advantage that the contrast of the display is improved when viewing the display off-axis. For example, in applications where the display has to be mounted so that it is always viewed off-axis then display performance is improved. Furthermore, rotation of the electrodes is simple to manufacture and allows the viewer to see high contrast.

The display device may further comprise a first polariser and a second polariser, wherein a polarisation axis of the first polariser is oriented at an oblique angle relative to said axis extending between two opposing edges of the pixel.

The first polariser may be disposed over the first encapsulation layer, and the second polariser may be disposed below the second encapsulation layer, so that the encapsulation layers are between the first polariser and the second polariser.

Alternatively, the first polariser may be disposed below the first encapsulation layer, and the second polariser may be disposed above the second encapsulation layer, so that the first polariser and the second polariser are between the encapsulation layers.

The polarizers may have to be aligned with the electrodes. Therefore aligning the polarizers at an oblique angle relative to the axis between the two opposing edges of the pixels improves contrast for viewers viewing the display off-axis.

A polarisation axis of the first polariser may be oriented parallel to the plurality of electrodes.

A polarisation axis of the second polariser may be oriented perpendicular to the polarisation axis of the first polariser.

The plurality of electrodes may form a grating of electrodes.

Each electrode of the plurality of electrodes may extend in a straight line.

Alternatively, each electrode of the plurality of electrodes may have a chevron shape. This is advantageous in FFS and IPS type LCD displays based on in-plane switching

An axis extending between two opposing ends of one of the plurality of electrodes may be oriented at an oblique angle relative to an axis extending between two opposing edges of the pixel. This is advantageous in cases where the electrodes have a chevron shape, however also applies where the electrodes extend in a straight line. When the electrodes have a chevron shape, the average angle of the chevron is oblique relative to the axis between two opposing edges of the pixel, however each side of the chevron is oriented at a different angle due to the shape of the chevron. This accounts for the difference in angles between two sides of the chevron shape, caused by the inherent shape of the chevron. In other words, overall the electrodes are rotated at an oblique angle relative to an axis extending between two opposing edges of the pixel.

The display device may further comprise: a first set of conductive lines connected to the plurality of pixels; and a second set of conductive lines connected to the plurality of pixels; wherein the first set of conductive lines and the second set of conductive lines are arranged to define a shape of each of the plurality of pixels.

The shape of each of the pixels may be square, wherein the plurality of electrodes are oriented such that at least one electrode of the plurality of electrodes extends laterally from a first side of a pixel to a second side of the pixel, wherein the first side of the pixel is oriented perpendicular to the second side of the pixel.

Alternatively, the shape of each of the pixels may be a parallelogram and has a pair of equal opposing angles, and the plurality of electrodes are oriented such that at least one electrode of the plurality of electrodes extends laterally from a first side of a pixel to a second side of a pixel, wherein the first side of the pixel is oriented at an oblique angle relative to the second side of the pixel. This has the advantage that the pixels appear to a viewer to extend horizontally or vertically across the display, when the display is conformally mounted a curved surface.

The shape of each of the plurality of pixels may be a rhombus or rhomboid.

The first set of conductive lines and the second set of conductive lines may form an active matrix array.

Alternatively, the first set of conductive lines and the second set of conductive lines may form a passive matrix array.

The display medium may be a liquid crystal display medium.

Advantageously, the display device may be flexible. This allows the device to be conformally mounted on a curved surface.

The display device may be for conformal mounting on a curved surface.

The display device may further comprise at least one contrast enhancing film. Contrast enhancing films reduce light leakage of dark parts of the display, therefore improving off-axis viewing quality.

The at least one contrast enhancing film may be oriented parallel to the polarisation axis of the first polariser.

At least one contrast enhancing film may be oriented parallel to the polarisation axis of the second polariser. This may be perpendicular to the polarisation axis of the first polariser. This may be in addition or as an alternative to the contrast enhancing film oriented parallel to the polarisation axis of the first polariser.

At least one contrast enhancing film may be integrated in the same layer as the first polariser or the second polariser. This has the advantage that manufacture of the display device is easier.

The oblique angle relative to an axis extending between two opposing edges of the pixel may be within a range of 0 degrees to 90 degrees.

Preferably, the oblique angle relative to an axis extending between two opposing edges of the pixel may be within a range of 15 degrees to 75 degrees.

Preferably, the oblique angle relative to an axis extending between two opposing edges of the pixel may be within a range of 30 degrees to 60 degrees.

More preferably, the oblique angle relative to an axis extending between opposing edges of the pixel may be 45 degrees. This improves contrast of the display when viewed at 45°.

The oblique angle relative to an axis extending between two opposing edges of the pixel may be uniform for the plurality of pixels. This has the advantage that the contrast is optimised for all pixels when all viewed from the same angle.

The display device may comprise n pixels, wherein n represents the total number of pixels of the display device. In embodiments, each of the n pixels is oriented at the oblique angle relative to an axis extending between two opposing edges of the pixel. That is, all of the pixels within the display device may be oriented at the same oblique angle between two opposing edges of the pixels.

According to a further aspect of the present disclosure, we provide a method of manufacturing a display device, the method comprising: forming a first encapsulation layer; forming a second encapsulation layer; forming a display medium between the first and second encapsulation layers, wherein the first encapsulation layer is disposed above an upper surface of the display medium and the second encapsulation layer is disposed below a lower surface of the display medium; forming a plurality of electrodes extending laterally through the display medium, wherein the plurality of electrodes are oriented at an oblique angle relative to an axis extending between two opposing edges of the pixel.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE DRAWINGS

The invention is diagrammatically illustrated, by way of example, in the accompanying drawings, in which:

FIG. 1 shows a simplified representation of a known active matrix array;

FIG. 2 illustrates an interior of a vehicle having a curved surface inclined at an oblique angle relative to a horizontal plane;

FIGS. 3(a) and 3(b) illustrate on-axis viewing of a display;

FIGS. 3(c) and 3(d) illustrate off-axis viewing of a display;

FIG. 4 illustrates the brightness of a theoretical display, showing a uniform colour, viewed from all angles;

FIG. 5 illustrates the brightness of a theoretical display, showing black, viewed from all angles;

FIG. 6 illustrates the brightness of an actual black display viewed from all angles;

FIG. 7 illustrates a configuration of electrodes within a liquid crystal display;

FIG. 8 illustrates an alternative configuration of electrodes within a liquid crystal display, according to one embodiment;

FIG. 9 illustrates an alternative configuration of electrodes within a liquid crystal display, according to a further embodiment;

FIG. 10(a) illustrates a configuration of electrodes within a liquid crystal display and polarizers;

FIG. 10(b) illustrates an alternative configuration of electrodes within a liquid crystal display and polarizers according to one embodiment;

FIG. 11 illustrates a cross section of a display device.

### DETAILED DESCRIPTION OF THE DRAWINGS

Embodiments will now be described by way of example only.

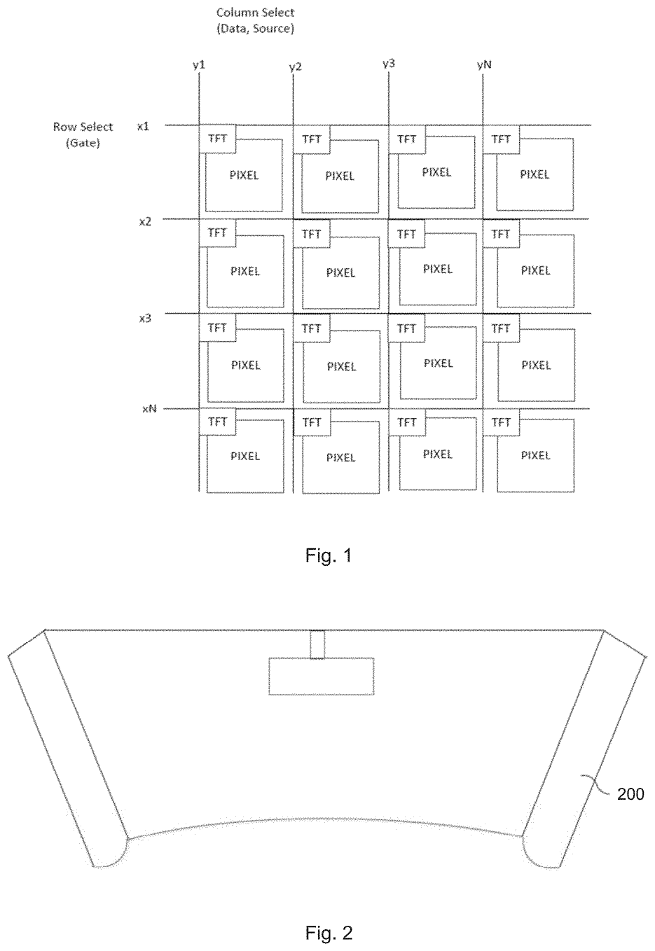

FIG. 1 shows a simplified representation of a known active matrix array. In an active matrix display device the emission of each pixel is typically controlled using one or more thin film transistor (TFT) located at the point of intersection between the x- and y-lines. The row electrode (x-line) is time-sequentially addressed single line by single line, and the emission intensity of each pixel is controlled by a signal from the corresponding column electrode (y-line) with each pixel actively maintaining the pixel state while other pixels are being addressed.

In both passive and active matrix display devices, the arrangement of the conductive lines defines the shape of pixels of the display device to be square or rectangle (due to the grid structure of the conductive lines).

FIG. 2 illustrates an interior of a vehicle having a curved surface inclined at an oblique angle relative to a horizontal plane. In this example the inclined curved surface is an A-pillar of a car, where the driver is likely to always be viewing at 45 degrees.

The display device in embodiments described below, advantageously provides improved display quality when the display device is viewed off-axis, from an angle of approximately 45° (in embodiments the display device can be modified to optimise viewing at viewing angles other than 45° in dependence on the application).

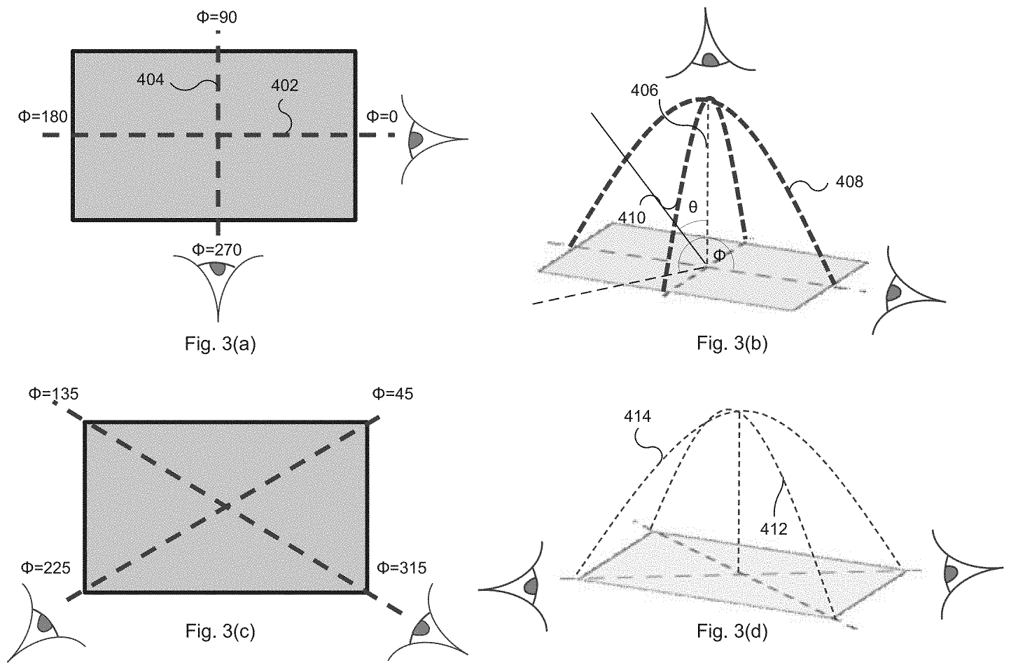

FIGS. 3(a) to 3(d) are used to illustrate the terms ‘on-axis’ and ‘off-axis’ when used to describe the viewing angle of a LCD display. In these, FIGS. 3(a) and 3(b) illustrate on-axis viewing of a display and FIGS. 3(c) and 3(d) illustrate off-axis viewing of a display.

A display device has a horizontal axis 402 and a vertical axis 404. A viewing direction is defined by an angle of inclination θ measured from the surface normal 406 of the display, and an azimuth angle Φ which is the angle that the projection of the viewing direction onto the surface of the display makes with the horizontal axis 402.

FIG. 3(a) illustrates the azimuth angle Φ increasing counter-clockwise around the plane of the display device. The display device is truly “on-axis” to the viewer if the viewing direction is parallel with either the horizontal axis 402 (i.e. the azimuth angle Φ=0° or 180°) or the vertical axis 404 (i.e. the azimuth angle Φ=90° or 270°).

As shown in FIG. 3(b), a viewer viewing the display device at a viewing direction specified by an azimuth angle Φ of 0° or 180° is viewing the display device on-axis regardless of the angle of inclination θ. That is, the viewer is viewing the display device on-axis regardless of where along dashed line 408 they are viewing the display device from. The dashed line 408 represents the series of positions with varying angles of inclination θ that correspond to on-axis viewing by virtue of having an azimuth angle Φ of 0° or 180°.

Furthermore as shown in FIG. 3(b), a further viewer viewing the display device at a viewing direction specified by an azimuth angle Φ of 90° or 270° is viewing the display device on-axis regardless of the angle of inclination θ. That is, the viewer is viewing the display device on-axis regardless of where along dashed line 410 they are viewing the display device from. The dashed line 410 represents the series of positions with varying angles of inclination θ that correspond to on-axis viewing by virtue of having an azimuth angle Φ of 90° or 270°.

FIGS. 3(c) and 3(d) illustrate viewers viewing the display device at a viewing direction specified by an azimuth angle Φ of 225° or 315°. The viewers in FIGS. 3(c) and 3(d) are viewing the display device off-axis.

The dashed line 412 represents the series of positions with varying angles of inclination θ having an azimuth angle Φ of 135° or 315°. The dashed line 414 represents the series of positions with varying angles of inclination θ having an azimuth angle Φ of 45° or 225°. A viewer viewing the display at the central point, where 412 and 414 intersect, would not be viewing the display off-axis as at this point the angle of inclination θ=0°. Similarly, at the ends of 412 and 414, the viewer is not viewing the display off-axis as the angle of inclination θ=90° or 270°.

In other words, the viewer is viewing the display off-axis when neither the angle of inclination θ or the azimuth angle Φ are 0°, 90°, 180°, or 270°.

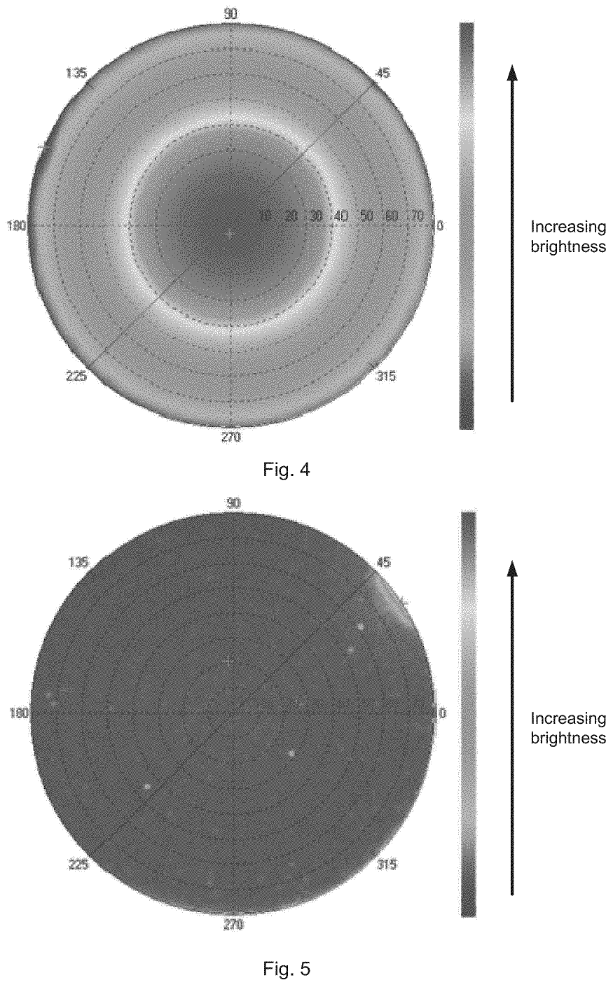

FIG. 4 illustrates the brightness of a theoretical display viewed from all angles when the display is displaying an even white colour. The plot is a polar plot, and therefore the centre point represents a viewer viewing the display straight on, θ=0°. The axis extending from the centre of the plot to the perimeter represents the angle of inclination θ. The axis extending around the outside circumference of the plot represents the azimuth angle Φ. The brightest viewing angle is shown as red (when θ=0°), and the darkest viewing angle shown as dark blue. The plot shows the relative brightness of viewing angles in comparison to the brightest viewing angle. It can be seen that for the white display the brightness of the display is even from any azimuth angle Φ, however the brightness of the display drops off as the angle of inclination θ increases.

FIG. 5 illustrates the brightness of a theoretical display viewed from all angles when the display is displaying an even black colour. Similarly to FIG. 4, the plot is a polar plot representing varying angle of inclination θ and azimuth angle Φ. The display is a theoretical, completely dark display in which black is represented by a complete absence of light. In this theoretical situation, the (very low) luminance is equal from all angles.

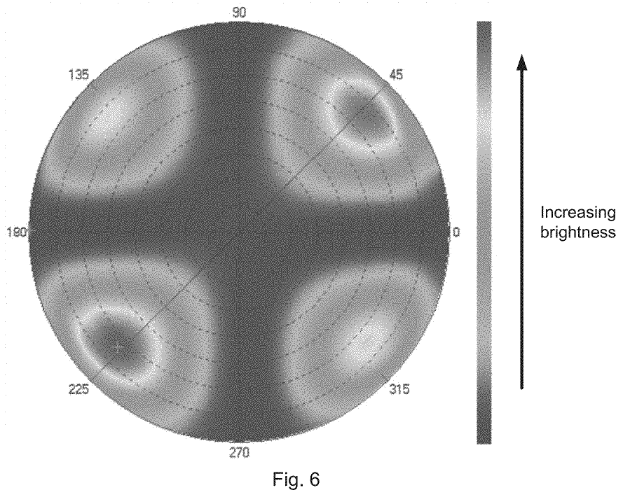

FIG. 6 illustrates the brightness of an actual display viewed from all angles when the display is displaying an even black colour. Similarly to FIGS. 4 and 5, the plot is a polar plot representing varying angle of inclination θ and azimuth angle Φ. The display is a known LCD display in a black state. Unlike the theoretical display, the contrast behaves very differently when the display is viewed off-axis, in particular when viewed at 45°.

On this plot, the straight line between points where Φ=90° and 270° (from top to bottom on the display) represents the line 410 in FIG. 3(b). The straight line between points where Φ=0° and 180° (from right to left on the display) represents the line 408 in FIG. 3(b). Along these two lines 408, 410 where the viewer is viewing the display on-axis, the brightness is low and there are no light leaks.

As shown in FIG. 6, when the viewer views the display off axis, there are significant light leaks (e.g. where Φ=45°, 135°, 225°, and 315°). These light leaks reduce the contrast of the display when viewed off-axis and therefore reduce the quality of image displayed by the display.

Embodiments of the present disclosure address these issues.

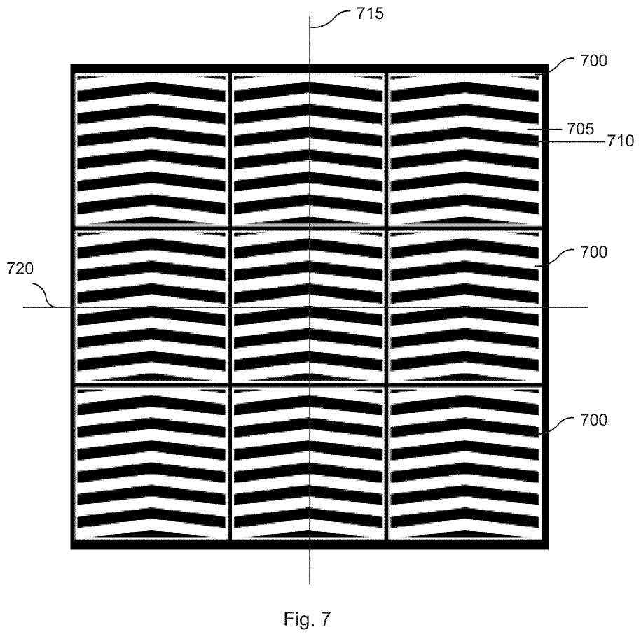

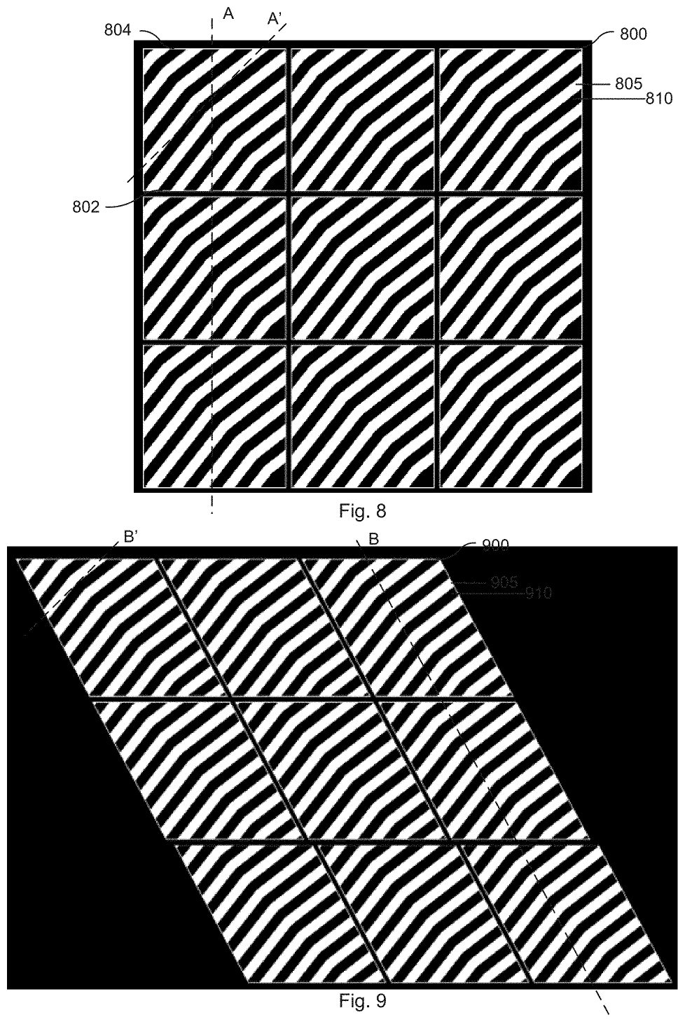

FIG. 7 illustrates a configuration of electrodes within a conventional liquid crystal display. FFS and IPS type LCDs are based upon “in-plane switching” of liquid crystal between a grating of electrodes. The display comprises a number of pixels 700, each with electrodes 705 extending across the display. Liquid crystal 710 is located between adjacent electrodes. In some types of LCD the electrodes are chevron shaped as shown in FIG. 7; however they may also be straight lines.

Generally in LCD displays, one of the polarization axes of the polarizers is approximately aligned with the electrodes, and the polarization axes of the two polarizers are perpendicular to each other. The polarizers do not have omnidirectional performance, and in particular have poor quality performance when viewed off-axis. In the display of FIG. 7, one of the polarization axes 720 is aligned horizontally and the other polarization axis 715 is aligned vertically, and therefore off-axis viewing from 45° would have poor contrast as shown in FIG. 6.

FIG. 8 illustrates an alternative configuration of electrodes within a liquid crystal display. In this display, the electrodes 805 within each pixel 800 are rotated relative to the edges of the pixels compared with the known configuration shown in FIG. 7. As the electrodes 805 are rotated, the polarizers are also rotated, therefore optimising off-axis viewing. The rotated display electrodes 805 improve contrast for off-axis viewing, without having to rotate the pixels themselves. Therefore this maintains the same routing layout with sources and gates perpendicular with electrical connections being made down one or two edges, as in the display shown in FIG. 7, and can be mounted easily. The display electrodes are rotated relative to the sources and gates. The electrodes may be rotated by 45° to optimise viewing from 45°. Alternatively, the angle of rotation may be chosen to optimise viewing from another angle. The angle of rotation may be the same as the desired viewing angle.

The electrodes 805 are oriented at an oblique angle relative to an axis, A, extending between two opposing edges 802, 804 of a pixel 800. This also applies to an axis extending between the other two edges of the pixel, in a perpendicular direction to A in this example. In this figure, the pixel electrodes 805 are provided with 6 to 16 degree shift forming the chevron shape; however they may also be straight lines.

The line A′ illustrates an axis extending between opposing ends of an electrode. A′ is oriented at an oblique angle relative to A. Therefore the chevron shaped electrode, on average, is oriented at an oblique angle relative to axis A.

In this embodiment all of the pixels 800 are oriented at the same oblique angle relative to the axis A between two opposing edges of the pixels 802, 804, so that none of the pixels 800 are parallel or perpendicular to the axis A between two opposing edges of the pixels 802, 804.

FIG. 9 illustrates an alternative configuration of electrodes within a liquid crystal display; in this embodiment the pixel shape is altered to improve the pixel fill-factor.

The electrodes within the pixels, and the polarizers, are rotated to improve contrast and viewing quality for a viewer viewing the display off axis. The electrodes 905 are oriented at an oblique angle relative to an axis, B, extending between two opposing edges of a pixel 900. This also applies to an axis extending between the other two edges of the pixel. In this figure, the pixel electrodes 905 are provided with 6 to 16 degree shift forming the chevron shape; however they may also be straight lines.

The line B′ illustrates an axis extending between opposing ends of a pixel. B′ is oriented at an oblique angle relative to B. Therefore the chevron shaped electrode, on average, is oriented at an oblique angle relative to axis B.

The display device 900 may be conformally mounted to the curved surface of the A-frame of a car which is tilted at an oblique angle. The pixels in the display device 900 have a rhombus or parallelogram shape to appear to a viewer to extend vertically across the display device or to extend horizontally across the display device, which improves image quality.

Conductive row electrodes and the conductive column electrodes are arranged to define a shape and size of each of the plurality of pixels that is uniform across the display. In this embodiment, each of the plurality of pixels is a parallelogram having a pair of equal opposing angles corresponding to the oblique angle of inclination of the curved surface onto which the display device is to be mounted.

Each of the equal opposing angles between adjacent sides of the pixel may be the same as the angle between the pixel electrodes and the axis extending between two opposing sides. Alternatively, each of the equal opposing angles between adjacent sides of the pixel may be different to the angle between the pixel electrodes and the axis extending between two opposing sides.

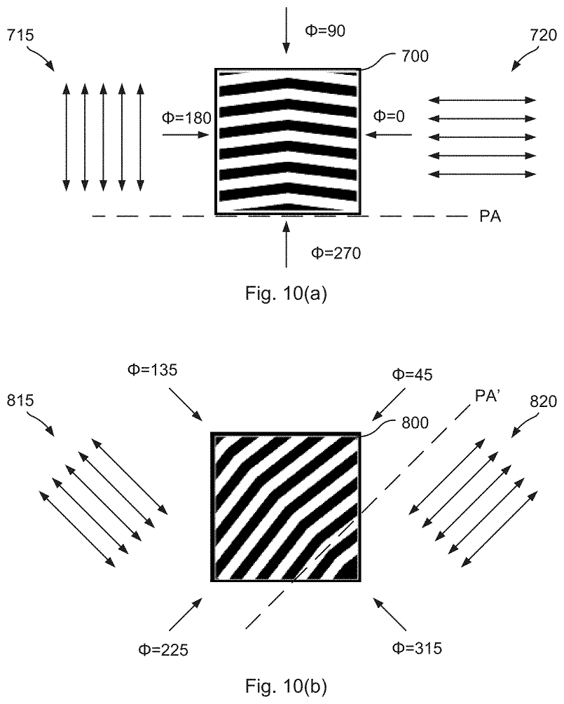

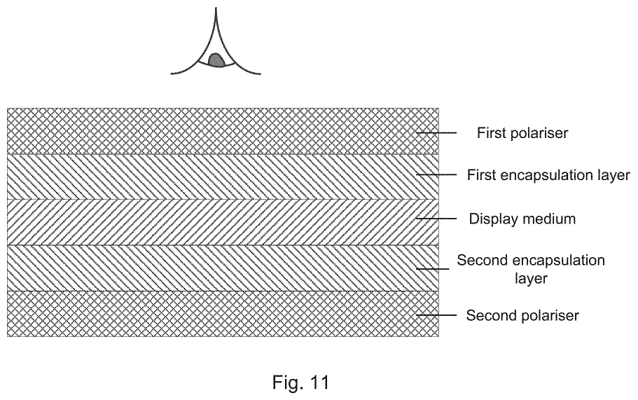

FIG. 10(a) illustrates a known configuration of electrodes within a liquid crystal display and polarizers. This configuration has the axes of polarization aligned to be horizontal and vertical. The electrodes within the LCD pixel 700 are aligned with the polarization axis, PA, of the polarizer 720, in that the electrodes extend in the same direction and at the same angle as the axis of polarization, PA. The polarization axis of the other polarizer 715 is perpendicular to the polarization axis of the polarizer 720 and to the electrodes within the pixel. This system is optimised for on axis viewing, as shown by the arrows representing on axis viewing angles. This display would have good contrast at 0°, 90°, 180°, and 270° viewing angles.

FIG. 10(b) illustrates an alternative configuration of electrodes within a liquid crystal display 800 and polarizers 815, 820 according to embodiments of the present disclosure. This configuration has the axis of polarization aligned at 45° to the horizontal and vertical. The electrodes within the LCD pixel 800 are aligned with the polarization axis, PA′, of the polarizer 820, in that the electrodes extend in the same direction and at the same angle as the axis of polarization, PA′. The polarization axis of the other polarizer 815 is perpendicular to the polarization axis of polarizer 820 and to the electrodes within the pixel. The chevron shaped electrodes are also rotated by 45° relative to an axis extending between two opposing sides of the pixel 800 compared to the known configuration shown in FIG. 10(a). This configuration allows for better contrast when viewed off-axis, in particular when viewed at 45°.

FIG. 11 illustrates a cross section of a display device. The display device includes (from top to bottom) a first polarizer, a first encapsulation layer, a display medium, a second encapsulation layer, and a second polarizer.

The first encapsulation layer, display medium, and second encapsulation layer form the display cell. The display electrodes (not shown) are formed extending through the display medium. These are rotated to improve contrast at an off axis viewing angle, for example at 45°.

The first polarizer is located above the display cell. The orientation of the first polarizer is also rotated to compliment the display electrodes within the display cell.

The second polarizer is located below the display cell, on the opposite side of the display cell to the first polarizer. The orientation of the second polarizer is also rotated to compliment the display electrodes within the display cell, and generally the second polarizer is perpendicular to the first polarizer to provide opposite polarization to the first polarizer.

The display may also include brightness enhancing and/or contrast enhancing films. In general, these are aligned with the polarization axes. The brightness enhancing films may also have reduced viewing quality when viewed off-axis, therefore rotating this in line with the polarisers improves off-axis viewing quality. Contrast enhancing films reduce light leakage of dark parts of the display; therefore rotating the contrast enhancing films in line with the polarisers improves off-axis viewing quality. This would be done by rotating the brightness or contrast enhancing film by the same oblique angle as the chevron and/or polariser rotation. The display device may be an LCD display device (the pixels having a first and second substrate) whereby the display medium is a liquid crystal display medium. The LCD display device may operate in accordance with one of a plurality of known technologies for example the LCD display device may be a twisted nematic (TN) display device, a fringe-field switching (FFS) display device, an in-plane switching (IPS) display device, a plane-to-line switching (PLS) display device, or operate in accordance with another known LCD technology not described herein.

The display device of the embodiments described above may be flexible, that is, the whole of the active area defined by the pixels of the display device exhibits flexibility i.e. can be bent multiple times without breaking. In particular the first and second encapsulation layers referred to above may be made of a deformable plastic substrate e.g. Cellulose triacetate (TAC), Polyethylene terephthalate (PET), Polyethylene naphthalate (PEN), Polyimide (PI), or acrylic based etc. (replacing the conventional glass substrate) such that the display device has flexibility and can be rolled, folded, bent, etc. In alternative embodiments, the first and second encapsulation layers referred to above are made of glass such that the active area defined by the pixels of the display device does not exhibit such flexibility however are shaped for conformal mounting to a curved surface. Alternatively, the display device could be a non-flexible type which could be merely comfortable to bend one time only.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the disclosure, whether alone or in any appropriate combination with any other feature disclosed or illustrated herein.

1. A display device, the device comprising:
a plurality of pixels, wherein each pixel comprises:
a first encapsulation layer;
a second encapsulation layer;
a display medium disposed between the first and second encapsulation layers, wherein the first encapsulation layer is disposed above an upper surface of the display medium and the second encapsulation layer is disposed below a lower surface of the display medium; and
a plurality of electrodes extending laterally through the display medium, wherein the plurality of electrodes are oriented at an oblique angle relative to an axis extending between two opposing edges of the pixel, and wherein each electrode of the plurality of electrodes has a chevron shape, and wherein an axis extending between two opposing ends of one of the plurality of electrodes is oriented at an oblique angle relative to the axis extending between two opposing edges of the pixel.

2. The display device according to claim 1, further comprising a first polariser and a second polariser, wherein a polarisation axis of the first polariser is oriented at an oblique angle relative to said axis extending between two opposing edges of the pixel.

3. The display device according to claim 2, wherein the polarisation axis of the first polariser is oriented parallel to the plurality of electrodes; and/or
wherein a polarisation axis of the second polariser is oriented perpendicular to the polarisation axis of the first polariser.

4. The display device according to claim 1, wherein the plurality of electrodes form a grating of electrodes.

5-7. (canceled)

8. The display device according to claim 1, further comprising:
a first set of conductive lines connected to the plurality of pixels;
a second set of conductive lines connected to the plurality of pixels;
wherein the first set of conductive lines and the second set of conductive lines are arranged to define a shape of each of the plurality of pixels.

9. The display device according to claim 8, wherein the shape of each of the pixels is square, and wherein the plurality of electrodes are oriented such that at least one electrode of the plurality of electrodes extends laterally from a first side of a pixel to a second side of the pixel, wherein the first side of the pixel is oriented perpendicular to the second side of the pixel.

10. The display device according to claim 8, wherein the shape of each of the pixels is a parallelogram and has a pair of equal opposing angles, and the plurality of electrodes are oriented such that at least one electrode of the plurality of electrodes extends laterally from a first side of a pixel to a second side of a pixel, wherein the first side of the pixel is oriented at an oblique angle relative to the second side of the pixel.

11. The display device according to claim 10, wherein the shape of each of the plurality of pixels is a rhombus or rhomboid.

12. The display device according to claim 8, wherein the first set of conductive lines and the second set of conductive lines form an active matrix array; or
wherein the first set of conductive lines and the second set of conductive lines form a passive matrix array.

13. The display device according to claim 1, wherein the display medium is a liquid crystal display medium; and/or
wherein the display device is flexible; and/or
further comprising at least one contrast enhancing film.

14. The display device according to claim 1, wherein the display device is for conformal mounting on a curved surface.

15. The display device according to claim 1, wherein the oblique angle relative to the axis extending between two opposing edges of the pixel is within a range of 0 degrees to 90 degrees.

16. The display device according to claim 15, wherein the oblique angle relative to the axis extending between two opposing edges of the pixel is within a range of 15 degrees to 75 degrees.

17. The display device according to claim 1, wherein the oblique angle relative to the axis extending between two opposing edges of the pixel is 45 degrees.

18. The display device according to claim 1, wherein the oblique angle relative to the axis extending between two opposing edges of the pixel is uniform for the plurality of pixels.

19. The display device according to claim 1, wherein the display device comprises n pixels, wherein n represents the total number of pixels of the display device, and wherein each of the n pixels are oriented at the oblique angle relative to the axis extending between two opposing edges of the pixel.

20. A method of manufacturing a display device comprising a plurality of pixels, the method comprising:
forming a first encapsulation layer;
forming a second encapsulation layer;
forming a display medium between the first and second encapsulation layers, wherein the first encapsulation layer is disposed above an upper surface of the display medium and the second encapsulation layer is disposed below a lower surface of the display medium;
forming a plurality of electrodes extending laterally through the display medium, wherein the plurality of electrodes are oriented at an oblique angle relative to an axis extending between two opposing edges of the pixel and wherein each electrode of the plurality of electrodes has a chevron shape, and wherein an axis extending between two opposing ends of one of the plurality of electrodes is oriented at an oblique angle relative to the axis extending between two opposing edges of the pixel.

21. The display device according to claim 16, wherein the oblique angle relative to said axis extending between two opposing edges of the pixel is within a range of 30 degrees to 60 degrees.
